(19) United States
(12) Patent Application Publication
(10) Pub. No.: US 2025/0061402 A1
(43) Pub. Date: Feb. 20, 2025

(54) CROWDSOURCED PRICE BASED SOFTWARE FEATURE IMPLEMENTATION

(71) Applicant: International Business Machines Corporation, Armonk, NY (US)

(72) Inventors: Natalia Russi-Vigoya, Round Rock, TX (US); Brett Witteck, Sunnyvale, CA (US); Tiberiu Suto, Franklin, NY (US); Labib Farag Labib Hanna Saad, new Cairo (EG); Muhammad Jawad Paracha, Karachi (PK)

(73) Assignee: International Business Machines Corporation, Armonk, NY (US)

(21) Appl. No.: 18/491,004

(22) Filed: Oct. 20, 2023

(30) Foreign Application Priority Data
Aug. 16, 2023 (PK) 534/2023

(51) Int. Cl. G06Q 10/0637; G06F 8/77; G06F 40/30; G06Q 30/0201

(52) U.S. Cl. CPC G06Q 10/06375; G06F 8/77; G06F 40/30; G06Q 30/0206

(57) ABSTRACT

A feature request and a price corresponding to the feature request are received. The feature request is validated, the validating determining an implementation cost of the feature request. Using a return on investment of the feature request, the feature request is selected for implementation, the return on investment computed using the implementation cost and the price. Implementation of the selected feature request is caused.

### BACKGROUND

The present invention relates generally to a method, system, and computer program product for software feature implementation management. More particularly, the present invention relates to a method, system, and computer program product for crowdsourced price based software feature implementation.

Crowdsourcing is the practice of obtaining information or participation in a task or project by enlisting others, typically using computers and via a communications network such as the Internet. The resulting information is referred to as crowdsourced information.

### SUMMARY

The illustrative embodiments provide a method, system, and computer program product. An embodiment includes a method that receives a feature request and a price corresponding to the feature request. An embodiment validates the feature request, the validating determining an implementation cost of the feature request. An embodiment selects, using a return on investment of the feature request, the feature request for implementation, the return on investment computed using the implementation cost and the price. An embodiment causes implementation of the selected feature request.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for crowdsourced price based software feature implementation in accordance with an illustrative embodiment;

FIG. 3 depicts an example of crowdsourced price based software feature implementation in accordance with an illustrative embodiment;

FIG. 4 depicts a continued example of crowdsourced price based software feature implementation in accordance with an illustrative embodiment;

FIG. 5 depicts a continued example of crowdsourced price based software feature implementation in accordance with an illustrative embodiment;

FIG. 6 depicts a continued example of crowdsourced price based software feature implementation in accordance with an illustrative embodiment;

FIG. 7 depicts a flowchart of an example process for crowdsourced price based software feature implementation in accordance with an illustrative embodiment.

### DETAILED DESCRIPTION

The illustrative embodiments recognize that software providers often maintain customer support sites, which customers or potential customers can use to provide feedback on product or service quality, report bugs, suggest additional features, or make other product improvement suggestions. Review sites are similar to customer support sites, but typically allow for feedback on multiple products and services, independently of the providers of those products and services. Some sites allow users to rate products or services, for example on a scale of zero to five stars, or aggregate upvotes (i.e., positive feedback) and downvotes (i.e., negative feedback) relative to a particular product or service. Software providers often use customer feedback and feature requests to decide which bugs to fix and which new features to implement. However, customer feedback and feature requests do not quantify an impact of a proposed feature or bug fix on a customer's business, and without such quantification it is difficult for a software provider to effectively prioritize the features and bug fixes that customers most want and are thus most likely to pay for. In addition, counting the number of requests for the same feature is ineffective, because some features might be popular but not important to a customer's core business. Thus, the illustrative embodiments recognize that there is a need to implement a quantification of an impact of a proposed feature or bug fix on a customer's business, in the form of a price a customer is willing to pay for a particular feature or bug fix.

The illustrative embodiments recognize that the presently available tools or solutions do not address these needs or provide adequate solutions for these needs. The illustrative embodiments used to describe the invention generally address and solve the above-described problems and other problems related to crowdsourced price based software feature implementation.

An embodiment can be implemented as a software application. The application implementing an embodiment can be configured as a modification of an existing software development management system, as a separate application that operates in conjunction with an existing software development management system, a standalone application, or some combination thereof.

Particularly, some illustrative embodiments provide a method that determines an implementation cost of a feature request, and selects, using a return on investment of the feature request, the feature request for implementation.

An embodiment receives a feature request. A feature request is a request to implement a feature or capability or fix a bug in an existing software product, or a request for a new software product that includes one or more features or capabilities. Optionally, the feature request includes a price a requestor of the feature is willing to pay for the feature. In one embodiment, feature requests are only visible to the feature originator and the embodiment itself. In another embodiment, feature requests are visible to other users of the embodiment, but a price included in a feature request is only visible to the feature originator and the embodiment itself. In another embodiment, both feature requests and their prices are visible to other users of the embodiment. In another embodiment, feature requests, prices, or both are visible to other users of the embodiment if a feature request originator opts into such visibility. Allowing visibility of feature requests and prices to other users permits another user to add its own price to an existing feature request, thus indicating additional support for an implementation of that feature request. In one embodiment, users are also able to vote on or rate their own or others' feature requests.

An embodiment uses a presently available natural language similarity analysis technique to determine if more than one received feature request refers to the same feature, or features that sufficiently similar to each other that the features can be considered to refer to the same feature. An embodiment aggregates feature requests that are sufficiently similar to each other into one aggregated feature request. As part of the aggregating, an embodiment adds prices in aggregated feature requests together to obtain an aggregated price of the aggregated feature request. An embodiment keeps track of which users submitted original feature requests that were aggregated together, as well as a price submitted as part of one of the original feature requests. Aggregation allows multiple users to work together to obtain implementation of a feature that might be too expensive for a single user to fund, and helps a software provider identify features and interactions customers value most.

An embodiment validates a feature request. A validated feature request has been accepted for eventual implementation, while an invalidated feature request has been rejected for implementation. As part of validating a feature request, one embodiment routes a feature request to one or more human experts, such as a development team, to determine feature implementation data, such as whether the feature request is implementable, relevant to a particular product or business goals, or already available in another form, as well as an implementation cost of the feature request. An implementation cost refers to how much it will cost (e.g., in developer time, testing time, marketing and product support, and the like) to implement a feature request. For example, fixing one bug might take one day of one junior developer's time, plus a fraction of the product support used in the next regularly scheduled software release, while adding support for a new processor architecture might take a six-person, senior developer team three months of full-time work plus the cost of a marketing campaign publicizing the new processor architecture support. An embodiment converts employee time to a monetary cost using a presently available employee cost estimation technique.

As part of validating a feature request, another embodiment determines feature implementation data, such as whether the feature request is implementable, relevant to a particular product or business goals, or already available in another form, as well as an implementation cost of the feature request, using one or more presently available automated techniques. For example, techniques are presently available to analyze natural language text within a feature request against natural language text describing an existing product or business goal to determine relevancy of the feature request to the existing product or business goal. As another example, techniques are presently available to estimate development and testing time of a feature request using a trained code evaluation model and data of a sufficiently similar feature implementation stored in a code repository.

As part of validating a feature request, an embodiment estimates a price of the feature request if a price was not originally included in the feature request. One embodiment estimates a price of the feature request using the implementation cost of the feature (e.g., the price is set to the implementation cost, or the implementation cost plus a profit percentage). Another embodiment estimates a price of the feature request that is aggregated into an aggregated feature request using prices in other feature requests that were aggregated into the aggregated feature request. For example, if four feature requests were aggregated together, and three feature requests included prices of $1000, $2500, and $3000, an embodiment might use the average ($2167) or median ($2000) of the three prices as the missing price. Other techniques to estimate a price of the feature request are also possible and contemplated within the scope of the illustrative embodiments.

An embodiment computes a return on investment of a validated feature request or aggregated feature request. One embodiment computes a return on investment as the price of a feature request (or total price, in an aggregated feature request) minus the implementation cost of the feature request. For example, if the price of a feature request is $1,000 and the implementation cost of the feature request is $500, the return on investment of the feature request is $500. Another embodiment uses a capped return on investment. If the computed return on investment is above the cap, (e.g., because the implementation cost is lower than the price the feature requestor was willing to pay) the embodiment reduces the price to keep the final return on investment equal to or below the cap. If the feature request is aggregated, an embodiment reduces the price for each original requester proportionally to an original request. Reducing the requestor's price on features that are comparatively inexpensive to implement or that are inexpensive when aggregated with others allows a software provider to increase customer goodwill.

An embodiment uses a return on investment of a validated feature request to select a feature request for implementation. One embodiment ranks validated feature requests according to their return on investment values, and selects one or more validated feature requests having the highest return on investment values for implementation. Another embodiment ranks validated feature requests according to their return on investment values, and uses the ranked requests as a priority order for implementation.

An embodiment informs a submitter of a selected feature request that the request has been selected for implementation, at the price in the selected feature request or a lower price. One embodiment proposes a transaction, in which completion of the selected, implemented, feature triggers payment of the price or the lower price. If the submitter approves the proposed transaction, one embodiment records the transaction in a distributed ledger, such as a blockchain. Once recorded, the transaction will be executed automatically when triggered by completion of the selected, implemented, feature.

An embodiment implements, or causes implementation of, a selected feature request. In particular, one embodiment uses a presently available code generation technique to implement a selected feature request. Another embodiment sends a selected feature request to a presently available code generation system for implementation. Another embodiment sends a selected feature request to a human developer, or team of human developers, for implementation.

An embodiment releases, responsive to receipt of payment according to the approved transaction, an implementation of the selected feature request to an originator of the selected feature request.

The manner of crowdsourced price based software feature implementation described herein is unavailable in the presently available methods in the technological field of endeavor pertaining to software development management. A method of an embodiment described herein, when implemented to execute on a device or data processing system, comprises substantial advancement of the functionality of that device or data processing system in determining an implementation cost of a feature request, and selecting, using a return on investment of the feature request, the feature request for implementation.

The illustrative embodiments are described with respect to certain types of feature requests, features, prices, aggregated feature requests, aggregated prices, price reductions, transactions, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

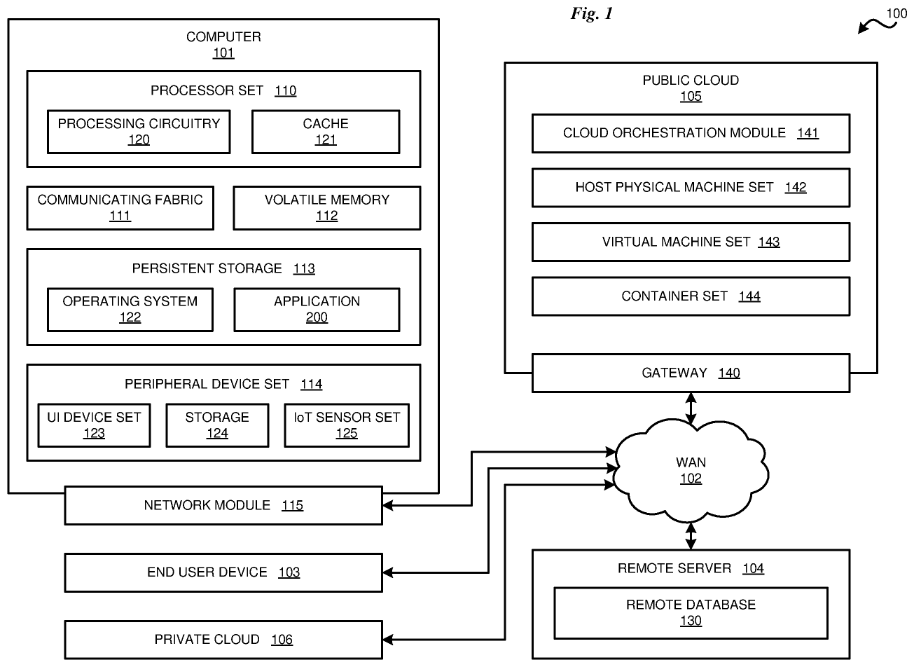

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a crowdsourced price based software feature implementation embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

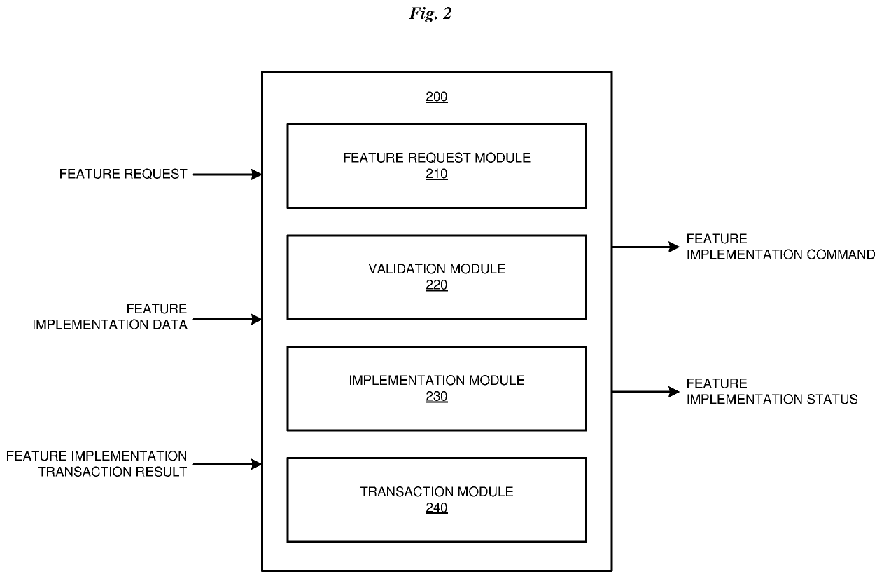

With reference to FIG. 2, this figure depicts a block diagram of an example configuration for crowdsourced price based software feature implementation in accordance with an illustrative embodiment. Application 200 is the same as application 200 in FIG. 1.

Feature request module 210 receives a feature request. A feature request is a request to implement a feature or capability or fix a bug in an existing software product, or a request for a new software product that includes one or more features or capabilities. Optionally, the feature request includes a price a requestor of the feature is willing to pay for the feature. In one implementation of module 210, feature requests are only visible to the feature originator and the embodiment itself. In another implementation of module 210, feature requests are visible to other users of application 200, but a price included in a feature request is only visible to the feature originator and application 200 itself. In another implementation of module 210, both feature requests and their prices are visible to other users. In another implementation of module 210, feature requests, prices, or both are visible to other users if a feature request originator opts into such visibility. Allowing visibility of feature requests and prices to other users permits another user to add its own price to an existing feature request, thus indicating additional support for an implementation of that feature request. In one implementation of module 210, users are also able to vote on or rate their own or others' feature requests.

Module 210 uses a presently available natural language similarity analysis technique to determine if more than one received feature request refers to the same feature, or features that sufficiently similar to each other that the features can be considered to refer to the same feature. Module 210 aggregates feature requests that are sufficiently similar to each other into one aggregated feature request. As part of the aggregating, module 210 adds prices in aggregated feature requests together to obtain an aggregated price of the aggregated feature request. Module 210 keeps track of which users submitted original feature requests that were aggregated together, as well as a price submitted as part of one of the original feature requests. Aggregation allows multiple users to work together to obtain implementation of a feature that might be too expensive for a single user to fund, and helps a software provider identify features and interactions customers value most.

Validation module 220 validates a feature request. A validated feature request has been accepted for eventual implementation, while an invalidated feature request has been rejected for implementation. As part of validating a feature request, one implementation of module 220 routes a feature request to one or more human experts, such as a development team, to determine feature implementation data, such as whether the feature request is implementable, relevant to a particular product or business goals, or already available in another form, as well as an implementation cost of the feature request. An implementation cost refers to how much it will cost (e.g., in developer time, testing time, marketing and product support, and the like) to implement a feature request. For example, fixing one bug might take one day of one junior developer's time, plus a fraction of the product support used in the next regularly scheduled software release, while adding support for a new processor architecture might take a six-person, senior developer team three months of full-time work plus the cost of a marketing campaign publicizing the new processor architecture support. Module 220 converts employee time to a monetary cost using a presently available employee cost estimation technique.

As part of validating a feature request, another implementation of module 220 determines feature implementation data, such as whether the feature request is implementable, relevant to a particular product or business goals, or already available in another form, as well as an implementation cost of the feature request, using one or more presently available automated techniques. For example, one implementation analyzes natural language text within a feature request against natural language text describing an existing product or business goal to determine relevancy of the feature request to the existing product or business goal. Another example implementation estimates development and testing time of a feature request using a trained code evaluation model and data of a sufficiently similar feature implementation stored in a code repository.

As part of validating a feature request, module 220 estimates a price of the feature request if a price was not originally included in the feature request. One implementation of module 220 estimates a price of the feature request using the implementation cost of the feature (e.g., the price is set to the implementation cost, or the implementation cost plus a profit percentage). Another implementation of module 220 estimates a price of the feature request that is aggregated into an aggregated feature request using prices in other feature requests that were aggregated into the aggregated feature request. For example, if four feature requests were aggregated together, and three feature requests included prices of $1000, $2500, and $3000, module 220 might use the average ($2167) or median ($2000) of the three prices as the missing price. Other techniques to estimate a price of the feature request are also possible.

Implementation module 230 computes a return on investment of a validated feature request or aggregated feature request. One implementation of module 230 computes a return on investment as the price of a feature request (or total price, in an aggregated feature request) minus the implementation cost of the feature request. For example, if the price of a feature request is $1,000 and the implementation cost of the feature request is $500, the return on investment of the feature request is $500. Another implementation of module 230 uses a capped return on investment. If the computed return on investment is above the cap, (e.g., because the implementation cost is lower than the price the feature requestor was willing to pay) the implementation reduces the price to keep the final return on investment equal to or below the cap. If the feature request is aggregated, module 230 reduces the price for each original requester proportionally to an original request. Reducing the requestor's price on features that are comparatively inexpensive to implement or that are inexpensive when aggregated with others allows a software provider to increase customer goodwill.

Module 230 uses a return on investment of a validated feature request to select a feature request for implementation. One implementation of module 230 ranks validated feature requests according to their return on investment values, and selects one or more validated feature requests having the highest return on investment values for implementation. Another implementation of module 230 ranks validated feature requests according to their return on investment values, and uses the ranked requests as a priority order for implementation.

Transaction module 240 informs a submitter of a selected feature request that the request has been selected for implementation, at the price in the selected feature request or a lower price. One implementation of module 240 proposes a transaction, in which completion of the selected, implemented, feature triggers payment of the price or the lower price. If the submitter approves the proposed transaction, one implementation of module 240 records the transaction in a distributed ledger, such as a blockchain. Once recorded, the transaction will be executed automatically when triggered by completion of the selected, implemented, feature.

Implementation module 230 implements, or causes implementation of, a selected feature request. In particular, one implementation of module 230 uses a presently available code generation technique to implement a selected feature request. Another implementation of module 230 sends a selected feature request to a presently available code generation system for implementation. Another implementation of module 230 sends a selected feature request to a human developer, or team of human developers, for implementation.

Transaction module 240 releases, responsive to receipt of payment according to the approved transaction, an implementation of the selected feature request to an originator of the selected feature request.

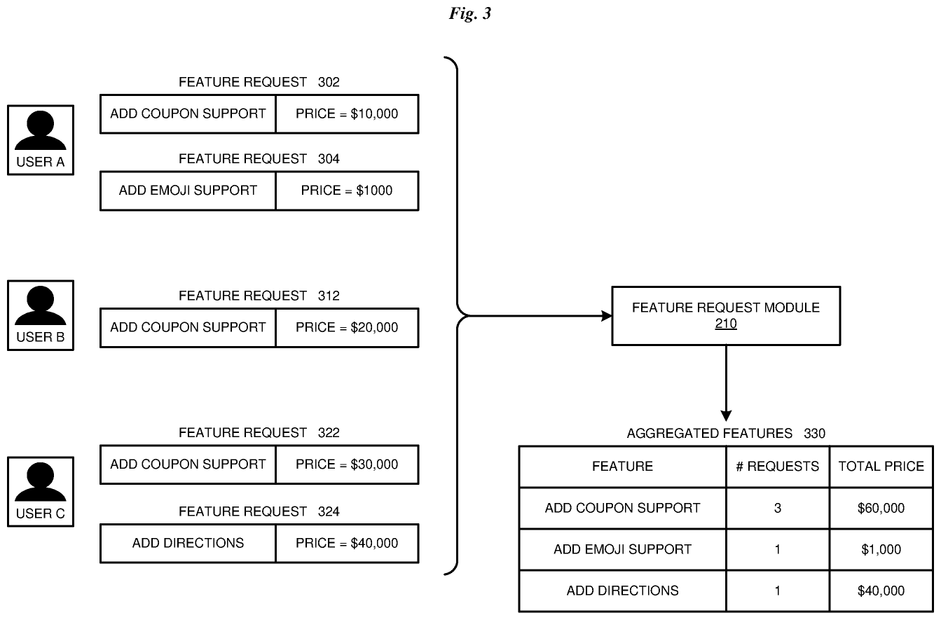

With reference to FIG. 3, this figure depicts an example of crowdsourced price based software feature implementation in accordance with an illustrative embodiment. The example can be executed using application 200 in FIG. 2. Feature request module 210 is the same as feature request module 210 in FIG. 2.

Feature request module 210 receives feature requests 302 and 304 from User A, feature request 312 from User B, and feature requests 322 and 324 from User C. Each feature request includes a corresponding price.

Module 210 aggregates feature requests that are sufficiently similar to each other into one aggregated feature request. As part of the aggregating, module 210 adds prices in aggregated feature requests together to obtain an aggregated price of the aggregated feature request. The results are depicted in aggregated features 330, which includes both aggregated and unaggregated feature requests.

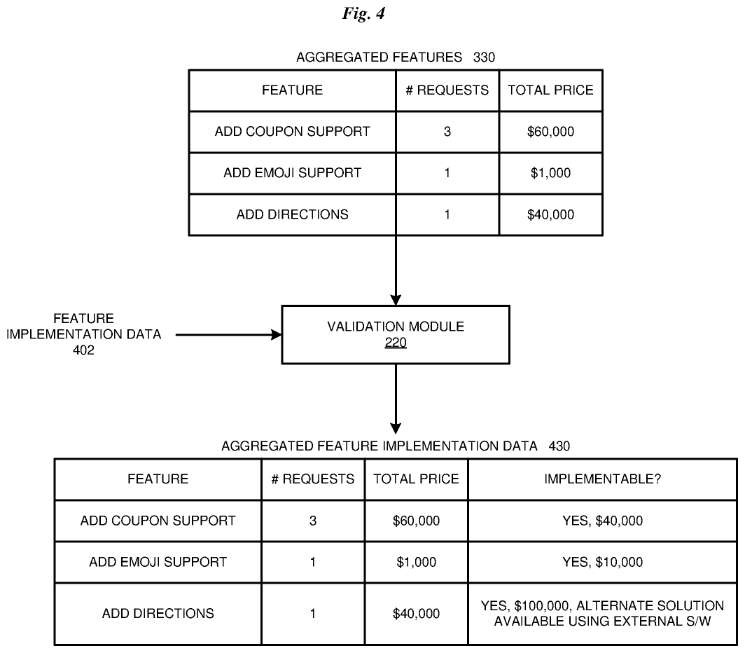

With reference to FIG. 4, this figure depicts a continued example of crowdsourced price based software feature implementation in accordance with an illustrative embodiment. Validation module 220 is the same as validation module 220 in FIG. 2. Aggregated features 330 is the same as aggregated features 330 in FIG. 3.

As depicted, validation module 220 uses feature implementation data 402 to validate the feature requests in aggregated features 330, generating aggregated features implementation data 430. The rightmost column of aggregated features implementation data 430 includes whether the feature request is implementable, the implementation cost of the feature request, and whether an alternate implementation is available.

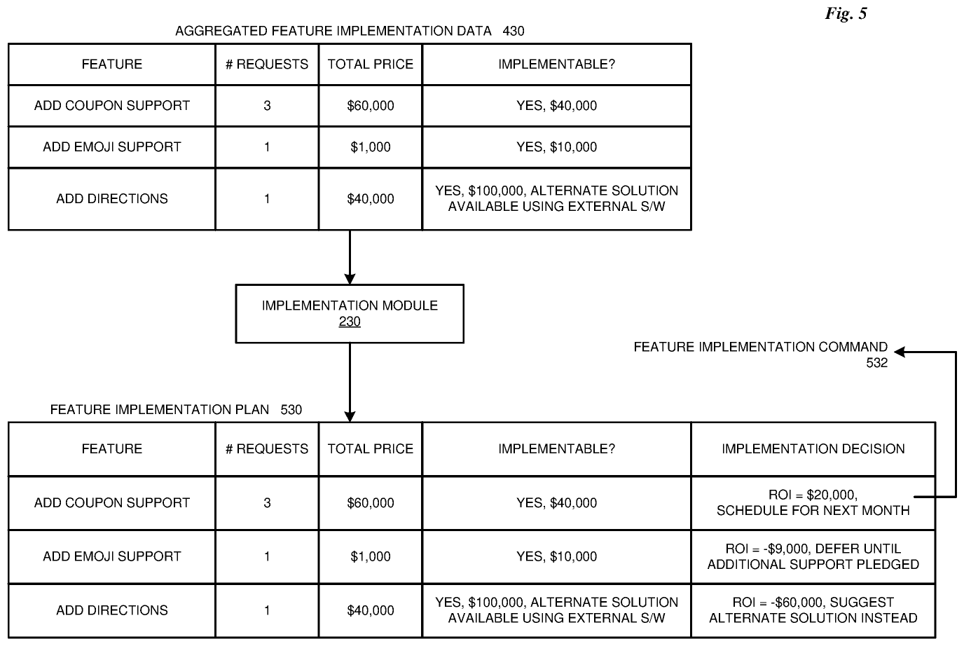

With reference to FIG. 5, this figure depicts a continued example of crowdsourced price based software feature implementation in accordance with an illustrative embodiment. Implementation module 230 is the same as implementation module 230 in FIG. 2. Aggregated features implementation data 430 is the same as aggregated features implementation data 430 in FIG. 4.

Implementation module 230 computes a return on investment of a validated feature request or aggregated feature request in aggregated features implementation data 430. The results are depicted in feature implementation plan 530. In particular, “add coupon support” (the subject of feature requests 302, 312, and 322 in FIG. 3, now aggregated together) has a positive return on investment and is implementable, resulting in feature implementation command 532 causing implementation of the aggregated feature request. “Add emoji support” has a negative return on investment, and thus module 230 defers implementation until additional support for implementing the feature is received. “Add directions” has a negative return on investment and an alternative solution is available, and thus module 230 suggests the alternative solution to an originator of this feature request.

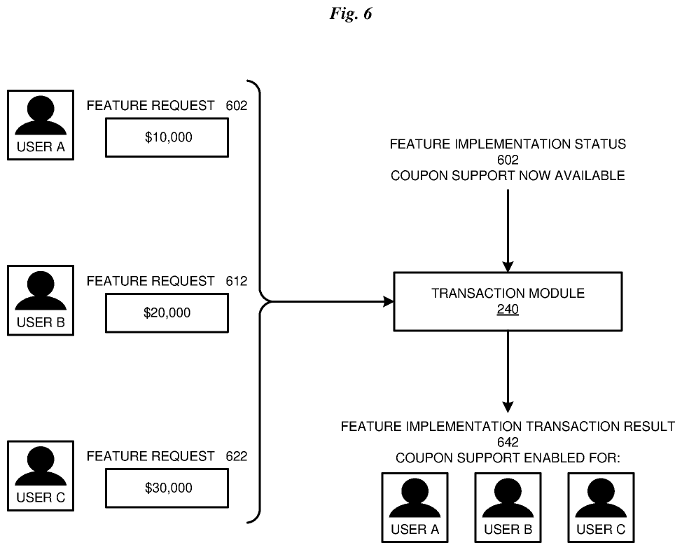

With reference to FIG. 6, this figure depicts a continued example of crowdsourced price based software feature implementation in accordance with an illustrative embodiment. Transaction module 240 is the same as transaction module 240 in FIG. 2. Aggregated features implementation data 430 is the same as aggregated features implementation data 430 in FIG. 4.

As depicted, transaction module 240 has received feature implementation status 602, as well as feature payments 602, 612, and 622 from Users A, B, and C respectively. The payments are the prices Users A, B, and C submitted as part of feature requests 302, 312, and 324 from User C. As a result, module 240 produces feature Implementation transaction result 642: the feature is enabled for Users A, B, and C.

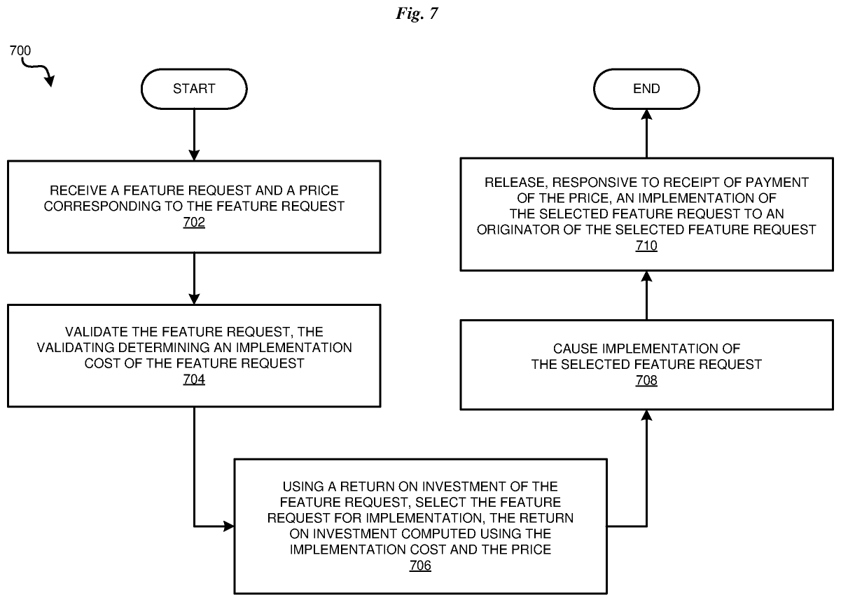

With reference to FIG. 7, this figure depicts a flowchart of an example process for crowdsourced price based software feature implementation in accordance with an illustrative embodiment. Process 700 can be implemented in application 200 in FIG. 2.

In block 702, the application receives a feature request and a price corresponding to the feature request. In block 704, the application validates the feature request, the validating determining an implementation cost of the feature request. In block 706, the application uses a return on investment of the feature request to select the feature request for implementation, the return on investment computed using the implementation cost and the price. In block 708, the application causes implementation of the selected feature request. In block 710, the application releases, responsive to receipt of payment of the price, an implementation of the selected feature request to an originator of the selected feature request. Then the application ends.

Thus, a computer implemented method, system or apparatus, and computer program product are provided in the illustrative embodiments for crowdsourced price based software feature implementation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
receiving a feature request and a price corresponding to the feature request;
validating the feature request, the validating determining an implementation cost of the feature request;
selecting, using a return on investment of the feature request, the feature request for implementation, the return on investment computed using the implementation cost and the price; and
causing implementation of the selected feature request.

2. The computer-implemented method of claim 1, further comprising:
determining, using a natural language similarity analysis, that the feature request and a second feature request have above a threshold similarity to each other; and
aggregating, into the feature request, the second feature request.

3. The computer-implemented method of claim 2, wherein aggregating, into the feature request, the second feature request comprises adding a second price corresponding to the second feature request to the price, a sum of the second price and the price used in computing the return on investment of the feature request.

4. The computer-implemented method of claim 3, wherein the second price is an estimated price.

5. The computer-implemented method of claim 1, further comprising:
determining that the return on investment is above a cap value; and reducing, by reducing the price, the return on investment to a value less than the cap value.

6. The computer-implemented method of claim 1, further comprising:
proposing, subsequent to the selecting, an automated transaction in which completion of implementation of the feature request triggers payment of the price; and
recording, subsequent to receiving an approval of the automated transaction, the automated transaction in a distributed ledger.

7. The computer-implemented method of claim 6, further comprising:
performing, subsequent to the completion of implementation of the feature request, the automated transaction, the performing triggering payment of the price.

8. The computer-implemented method of claim 1, further comprising:
releasing, responsive to receipt of payment of the price, an implementation of the feature request to an originator of the feature request.

9. A computer program product comprising one or more computer readable storage medium, and program instructions collectively stored on the one or more computer readable storage medium, the program instructions executable by a processor to cause the processor to perform operations comprising:
receiving a feature request and a price corresponding to the feature request;
validating the feature request, the validating determining an implementation cost of the feature request;
selecting, using a return on investment of the feature request, the feature request for implementation, the return on investment computed using the implementation cost and the price; and
causing implementation of the selected feature request.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, further comprising:
determining, using a natural language similarity analysis, that the feature request and a second feature request have above a threshold similarity to each other; and
aggregating, into the feature request, the second feature request.

13. The computer program product of claim 12, wherein aggregating, into the feature request, the second feature request comprises adding a second price corresponding to the second feature request to the price, a sum of the second price and the price used in computing the return on investment of the feature request.

14. The computer program product of claim 13, wherein the second price is an estimated price.

15. The computer program product of claim 9, further comprising:
determining that the return on investment is above a cap value; and reducing, by reducing the price, the return on investment to a value less than the cap value.

16. The computer program product of claim 9, further comprising:
proposing, subsequent to the selecting, an automated transaction in which completion of implementation of the feature request triggers payment of the price; and
recording, subsequent to receiving an approval of the automated transaction, the automated transaction in a distributed ledger.

17. The computer program product of claim 16, further comprising:
performing, subsequent to the completion of implementation of the feature request, the automated transaction, the performing triggering payment of the price.

18. The computer program product of claim 9, further comprising:
releasing, responsive to receipt of payment of the price, an implementation of the feature request to an originator of the feature request.

19. A computer system comprising a processor and one or more computer readable storage media, and program instructions collectively stored on the one or more computer readable storage media, the program instructions executable by the processor to cause the processor to perform operations comprising:
receiving a feature request and a price corresponding to the feature request;
validating the feature request, the validating determining an implementation cost of the feature request;
selecting, using a return on investment of the feature request, the feature request for implementation, the return on investment computed using the implementation cost and the price; and
causing implementation of the selected feature request.

20. The computer system of claim 19, further comprising:
determining, using a natural language similarity analysis, that the feature request and a second feature request have above a threshold similarity to each other; and
aggregating, into the feature request, the second feature request.
